(19) United States
(12) Patent Application Publication
(10) Pub. No.: US 2019/0343127 A1
(43) Pub. Date: Nov. 14, 2019

(54) AGRICULTURAL COMPOSITION FOR INCREASING CROP YIELDS

(71) Applicant: INVERAN CORP SPA, Santiago (CL)

(72) Inventor: Rene Alejandro ANDRADE NIKLITSCHEK, Santiago (CL)

(21) Appl. No.: 16/403,984

(22) Filed: May 6, 2019

Related U.S. Application Data
(60) Provisional application No. 62/668,504, filed on May 8, 2018.

(51) Int. Cl. A01N 65/10; A01N 27/00; A01N 65/38; A01N 65/34; A01N 37/10; A01N 25/02

(52) U.S. Cl. CPC A01N 65/10; A01N 27/00; A01N 25/02; A01N 65/34; A01N 37/10; A01N 65/38

(57) ABSTRACT

The invention relates to a composition comprising at least one phytosteroids component, a fulvic acid component, a hydroxyacids component, a carotenes component, and an ionic liquids component.

### CROSS-REFERENCE TO RELATED APPLICATIONS

This application claims priority to U.S. Provisional Application No. 62/668,504, filed May 8, 2018, the disclosure of which is incorporated herein by reference.

### TECHNICAL FIELD

The evaluated invention is a composition composed of a range of substances extracted from various plants. Application of the novel composition leads to changes that sustain increased yields of the harvested crops.

### BACKGROUND

There is a great demand for agricultural products to feed the ever-increasing number of humans and animals on our planet. Genetics has made a major contribution to creating new plant varieties that increase yield. In addition, agrochemicals have played a major role in helping to achieve continued yield increase of crop plants. These have largely focused on the control of pests such as insects, fungi, bacteria or virus or competition from weeds.

However, crop plants encounter major stresses during their growth cycle that limit their potential for yield increases. This is particularly important today, as climate change already affects major areas of crop production.

There are different sources of stress that affect plants, such as biotic or abiotic stresses such heat or drought, salinity or flooding, among others. The search for treatments of plants that can ameliorate these stresses is an active field of investigation by academics and companies alike. Thus, a pending problem to be solved is finding alternatives to products mentioned above.

The present invention is directed to solve said problem by providing a novel composition including various sources of plant extracts capable of overcoming these limitations.

A patent document search was conducted to find disclosures similar to the present invention. The following is a selection of documents close to the present invention, although none of them describes either each of the components individually or the combination of the components present in the composition of the present invention, nor the surprising results obtained with it.

US2014045697A1 describes the use of derivatives of androstanediol as growth regulator in plants. This document refers to a class of steroid in the formulation, however, it does not include any of the other components of the present invention, so it is estimated that this document does not affect the patentability.

WO2011094219A1 describes formulations that include at least one lipid and at least one surfactant. It also describes the application of the formulation to plants or crops, where the application of the formulation works as a pesticide, herbicide, fungicide, among others. The text notes that steroids can be used as a base lipid composition. This formulation includes only one of the components described in the present invention, thus, it is estimated that this document does not affect patentability.

US2011053773A1 describes methods to improve the nutritional content of plants. The method consists in applying a composition that includes either alone or in conjunction, growth regulators, herbicide, pesticide, nematicide, miticide, defoliants, among others, in combination with a herbicide safener. The composition described herein is not close to the composition of the present invention, thus it is not likely to affect the patentability.

US2005150012A1 describes a method for stimulation of the root system in plants, based on the expression of cytokinin oxidase from nucleic acids. The document does not describe a composition as the one of the present invention, and thus, it is considered that it would not affect the patentability.

To the best of the knowledge of the inventors, there are no disclosures describing a composition such as the one described in the present document.

### BRIEF DESCRIPTION OF TABLES

Table 1: Percentage composition (w/v) of each component of the composition

Table 2: Results of harvested yield of cherries from field trials

Table 3: Results of harvested yield of sugar beets in first field trial

Table 4: Results of harvested yield of sugar beets in second field trial

Table 5: Results of harvested yield of turnips in field trials

Table 6: Timing of application of novel composition to potatoes

Table 7: Comparison of harvested yield of potatoes in first field trial

Table 8: Comparison of number of potato tubers in first field trial

Table 9: Comparison of harvested yield of potatoes in second field trial

Table 10: Comparison of number of tubers in second field trial

Table 11: Comparison of harvested yield of tomatoes in field trials

Table 12: Timing of application of novel composition to table grapes

Table 13: Comparison of table grape plant condition in field trial

Table 14: Comparison of harvested yield of table grapes from field trials

Table 15: Dose of application of the Composition of the invention in almonds in field trial

Table 16: Timing of Foliar application of novel composition to almonds

Table 17: Comparison of harvested yield of almond in field trial

Table 18: Comparison of frost damage in avocado trees in field trial

Table 19: Comparison of harvested yield of avocado in field trial

Table 20: Timing of Foliar application of novel composition to pomegranate trees

Table 21: Comparison of pomegranate condition in field trial

### SUMMARY OF THE INVENTION

The present invention corresponds to a composition comprising at least one phytosteroids component, a fulvic acid component, a hydroxyacids component, a carotenes component, and an ionic liquids component.

### DETAILED DESCRIPTION OF THE INVENTION

As previously stated, the present invention corresponds to a composition for the treatment of crop plants. Among the advantages of the composition of the present invention, the following can be noted:
Increases yield of plants treated in the correct way
Actively protects plants against different stresses
The plant can use the different components of the novel composition of the present invention either for root and shoot development, flowering, fruit and tuber growth, general health status, among others.
The composition is water-soluble and as such, it does not require organic solvents which may have negative effects in the environment, and can be applied for irrigation or through foliar application;
The composition is completely innocuous for humans, animals, and the environment, wherein stock solutions can be disposed freely without damage to the environment;
The composition does not include elements toxic to humans or animals, and as such, it can be applied with the presence of operators.
The composition is easily absorbed by the plant.
The crop suffers less damage by oxidation of lipid bilayer membranes and thus, maintains a better gas and metabolites exchange and therefore metabolic processes are more efficient.
Increase in the efficiency of self-defense in situations of biotic and abiotic stress allows the plant to be able to reduce the use of energy and direct it to the production of tissues for growth and reproduction.

The novel composition of the present invention comprises at least but is not limited to the following active components:

i. A phytosteroids component,

ii. A fulvic acid component,

iii. A hydroxyacids component,

iv. A carotenes component,

v. An ionic liquids component.

In a more specific embodiment, the percentage of each component of the composition of the present invention is specified in Table 1.

TABLE 1
Percentage composition (w/v) of each of the components
of the composition of the invention

| | % Percentage | % Preferred |
|---|---|---|
| | composition | percentage |
| Component | (w/v) range | composition (w/v) |
| Phytosteroids component | 10-30 | 20 |
| Fulvic acid component | 10-40 | 25 |
| Hydroxyacids component | 1-20 | 5 |
| Carotenes component | 1-20 | 5 |
| Source of ionic liquid | 40-60 | 50 |

Phytosteroids Component

In a more specific embodiment, the phytosteroids component including brassinosteroids corresponds to extract enriched in phytosteroids. In a non-limiting embodiment, the phytosteroids component can be obtained from many plant species. An example are extracts of the following selected plants:

Quillaja saponaria, Phoenix dactylifera, Lolium perenne, Oryza sativa, Phalaris canariensis, Secal cereale, Triticum astivum, Zea mays, Lilium spp, Erythronium japanicum, Tulipa gesnerian, Typha latifo, Alnus glutinosa, Cannabis sativa, Gypsophilla perfoliata, Lychnis viscaria, Beta vulgaris, Castanea crenata, Fagopyrum seculentum, Rheum rhabarbarum, Apium, graveolens, Dauca spp, Arabodpsis thaliana, Brassica spp, Raphanus sativus, Cassia spp, Dolichos sp, Robinia sp, Acacia, Vicia faba, Phaseolus vulgaris, Eucalyptus, Citurs, Eriobotrya japonica, Thea sinensis, Helianthus annuus, Solidago altissima, Echium plantagineum, Pharbitis purpurea, Cucurbita moschata, Perilla frutescens, Nicotiana tabacum, Lycopersicon esculentum, Cupressus arizonica, Pinus spp, Cryptomeria japonica, Picea spp, Ginko biloba, Avena, Zea mays, Broccoli, Cauliflower, potato, oranges, apples, Brussels sprouts, onions, beans, Marchantia polymorphia amongst others but not limited to these plants.

Fulvic Acid Component

In a specific embodiment, the fulvic acid component can be obtained from a range of sources such as composting plant material, volcanic soil, other soils samples, marine sediments or agricultural soils amongst others. In an even more specific embodiment, the plant material that is composted is selected among a broad range of plant residues. In a specific embodiment, the plant material is obtained from tea, coffee, sugar cane, blackstrap molasses and other plants. In a more specific embodiment, the plant residue is a vermin-compost. In a more specific embodiment, the vermin-compost is subjected to a liquid extraction producing liquid humus which is filtered, and thus is produced the fulvic acid component.

Hydroxyacids Component

In a specific embodiment, the hydroxyacids component is preferably a source of β-hydroxyacid (BHA). In an even more specific and non-limiting embodiment, the source of BHA is obtained from a plant extract, more specifically from a plant selected among Schinus molle, Salix spp various berries, papaya, pine apple but not limited to these plants as well as milk and yoghurt. In a particular embodiment, the source of BHA is obtained by an aqueous extraction of the previously mentioned plants that have been ground. In a specific embodiment, the aqueous extraction is performed at a temperature of between 80° C. and 120° C. producing an infusion. Said infusion is further filtered and later lyophilized obtaining the source of BHA.

Carotenes Component

In a specific embodiment, the carotenes component is obtained from an aqueous extraction of carotene-rich plants, such as for example tomato, peppers, guavas, banana, carrots, pine apples plums, mangoes, nectarines, orange, peach, papaya, apricots, melons, watermelons, squash, pumpkin, sweet potatoes, spinach, corn, passion fruit, red palm oil. amongst others but not limited to these plants. Said aqueous extraction is lyophilized and the resulting material is subjected to a second extraction step. In a specific embodiment, the second extraction step is a supercritical fluid extraction. In an even more specific embodiment, the supercritical fluid extraction is performed using carbon dioxide as solvent, and the process is performed at a pressure of 5 to 15 MPa, more preferably at 10 MPa, producing the carotenes component.

Source of Ionic Liquid

In a specific embodiment, the ionic liquid is obtained by mixing liquid humus, lecithin and water.

Method of Use

The mixture of the different components of the composition is prepared to generate a composition as indicated in the present invention. The composition can be applied as a foliar spray using conventional spray equipment as predetermined doses depending on the plant species or by irrigation. Application can be at several stages during the growth cycle of the crop, in particular at the onset of flowering, during flowering or close to harvest of the crop, i.e., during periods of high stress for the plants, starting from sowing until harvest. The doses used vary between different crops plants and need to be determined empirically.

In a more specific embodiment, the recommended dose is between 0.5 liters per hectare in crops and smaller fruit trees, and of 1 liter for greater fruit trees. In a further embodiment, the composition of the invention should be applied at least 3 times per each growing season, during pre-flowering time, during flowering time, and at the time of harvest.

The advantages that some selected farmers have observed and their effects are the following:
Change of color of the crop toward a more intense green improving photo photosynthesis.
Leaves more open with greater exposure to the sun showing less stress.
Greater root growth, improving the absorption of nutrients.
Greater flowering and crop uniformity, showing a strong and less stressed crop.
Better health status of the crop with a lesser requirement of pesticides.
Higher fruit setting, thus ensuring higher production.
Absence of residues in the crop.
Harvest with desired commercial size, uniformity and health.
Rapid recovery from situations of biotic and abiotic stresses.
Increased production

Unlike other products, the composition of the invention does not incorporate hormones or specific nutrients to act directly in certain metabolic processes that may or may not be required for the plant, but instead, provide a specific mixture of components that help to improve plant performance. This is the reason why the novel composition of the invention has such good results in different crops.

### DESCRIPTION OF EMBODIMENTS

### Example 1: Obtaining Each of the Components of the Composition of the Invention

### Source and Extraction of Phytosteroids

1. Grinding plant leaves
2. Performing an aqueous extraction with water at a temperature selected between 40° C. to 70° C., more preferably at 60° C., producing an aqueous solution;
3. Filtering and concentrating the aqueous solution under vacuum conditions, producing a concentrate (dry extract);
4. Performing an enzymatic hydrolysis, using an esterase enzyme, producing the final phytosteroids component.

In a more specific embodiment, the enzymatic hydrolysis is performed by diluting the dry extract in water, more preferably bi-distilled water, at a concentration of 0.5 to 2 g per 50 ml of water. An estearase solution at a concentration of 50 units/ml prepared in a buffered solution at pH 7.5 is added dropwise to the dry extract solution while stirring constantly, maintaining pH at 7.5 and a temperature between 15° C. and 25° C., more preferably at 22° C. After a period of 30 min to 100 min a white precipitate is obtained. The white precipitate is washed twice with bi-distilled water, and later is centrifuged for at least 15 min at 6,000 g. The concentrate is filtered and dried in an oven for at least 30 hours, more preferably 48 hours, at a temperature between 30 and 40° C., more preferably at 37° C.

Source and Extraction of Fulvic Acid

The fulvic acid component was obtained by composting residual plant material obtained from tea and coffee. Said plant residues were subjected to vermicomposting and later, the obtained compost was subjected to a liquid extraction. The obtained liquid was filtered and the fulvic acid component is the result of said filtration step.

Source and Extraction of Hydroxyacids

The source of BHA was obtained by an aqueous extraction of Schinus molle ground leaves at a temperature of 100° C. The resulting infusion was filtered and lyophilized producing the source of BHA.

Source and Extraction of Carotenes

Tomatoes and carrots were ground and mixed, and further subjected to an aqueous extraction. The resulting liquid extract was further lyophilized. The obtained dry powder was subjected to a supercritical carbon dioxide extraction at a pressure of 10 MPa. using conventional procedures.

Source of Ionic Liquid

The ionic liquid was obtained by mixing liquid humus, lecithin and water.

### Examples: Evaluation of Effects in the Field of Treatment of Plants with the Composition

Standard methods are used for the evaluation of the physiological effects in the crop. Final crops yield and crop parameters were determined using standard method.

In the following examples, a composition according to the present invention was used, as the one described in Table 1, in the column corresponding to % Preferred percentage composition (w/v).

### Example 2: Application of the Composition of the Invention to Cherry Trees General Data

An area of 2.8 ha of cherry in production planted with “Regina” and “KORDIA” varieties was divided so that part of the areas was not treated and the other treated with the composition. The total area treated with the composition of the invention for variety “Regina” was 0.64 hectares and for variety “Kordia” was 0.32 hectares. The rest was used as control.

Objectives

The purpose of this filed trial was to determine the impact of the application of the composition of the invention on cherries trees.

Materials and Method

There were two treatments T0=No application of composition of the invention and T1=Foliar application of the Composition of the invention. Applications were made every 10 days at a dose of 1 liter per hectare.

TABLE 2
Results of harvested yield of cherries from field trials

| | With composition | Without composition |
|---|---|---|
| Variety | (kg) | (kg) |
| Regina | 11281 | 10564 |
| Kordia | 13400 | 11081 |

Results

The trees treated with the composition produced a greater yield of fruit in the range of 6-20% in comparison with untreated trees.

### Example 3: Application of the Composition of the Invention to Fodder Crops General Information

The plot used in this assay comprised an area of approximately 22,000 hectares, in which the surface covered by the crops was an average of 500 hectares. Fodder crops used in the analysis were sugar beets and turnips.

Objectives

The purpose of this field trial was to determine the impact of the application of the composition of the invention on sugar beets and turnips.

Materials and Method

The application of the composition of the invention was done via spraying, at a dose of 500 cc/Ha. Applications were repeated every 14 days until harvest.

The treatments were identified as T1=without the application of a composition of the invention and T2=with application of composition of the invention, each with 4 replicates per treatment. For the collection of data, a framework of 1 m² was used chosen completely at random, for the areas under investigation in order to quantify crop production.

All the plant material of the experimental unit (1 m²) was removed, for further weight analysis. Also, the roots were grouped according to their size and were further categorized as small, medium, or large.

The beet sample was subjected to a measurement of dry matter, metabolizable energy and amount of fiber. Performance parameters were evaluated, and size in the beet crops and forage turnips. Two evaluations of yield (kg/m²) were conducted for beet, whereas for turnip one measurement was made.

The results of the measurements are detailed below:

TABLE 3
Results of harvested yield of sugar beets from first field trial

| | | With no | Applying the |
|---|---|---|---|
| | | composition of | composition of |
| | | the invention | the invention |
| Trial 1 | Sample | (T1) kg | (T2) kg |
| Beet | 1 | 4.27 | 9.78 |
| Beet | 2 | 6.8 | 8.6 |
| Beet | 3 | 6.73 | 8.2 |
| Beet | 4 | 6.43 | 8.35 |
| Average | | 6.06 | 8.73 |
| Estimated production per hectare | | 60,575 | 87.325 |
| % dry matter | 13% | 7,693 | 11,090 |

| | |
|---|---|
| Increase | 44% |

Results

In the first trial of sugar beet, the obtained data showed that the treatment applied with novel composition of the invention (T2) yielded an estimated increase in the yield of 26,750 Kg. This represents a 44 percent increase of the productivity over the treatment without the composition of the invention.

TABLE 4
Results of harvested yield of sugar beets from second field trial

| | | With no | Applying the |
|---|---|---|---|
| | | composition of | composition of |
| | | the invention | the invention |
| Trial 2 | Sample | (T1) kg | (T2) kg |
| Beet | 1 | 6.0 | 12.5 |
| Beet | 2 | 9.9 | 12.0 |
| Beet | 3 | 10.1 | 12.8 |
| Beet | 4 | 8.3 | 18.4 |
| Beet | 5 | 14.5 | 8.1 |
| Average | | 9.76 | 12.76 |
| Estimated production per hectare | | 97,600 | 127,600 |
| % dry matter | 13% | 12,395.20 | 16,205.20 |

| | |
|---|---|
| Increase | 44% |

Results

As in the trial 1, the increase in yield of the treatment with the composition of the invention represents a 44 percent of the production obtained with the treatment without the composition of the invention.

TABLE 5
Results of harvested yield of turnips from field trials

| | | With no | Applying the |
|---|---|---|---|
| | | composition of | composition of |
| Trial 1 | Sample | the invention | the invention |
| Turnip | 1 | 14.3 | 10.3 |
| Turnip | 2 | 10.6 | 16.1 |
| Turnip | 3 | 10.3 | 13.2 |
| Turnip | 4 | 11.9 | 21.8 |
| Average | | 11.78 | 15.35 |
| Estimated production per hectare | | 117,750 | 153,500 |
| % dry matter | 13 | 14,954.25 | 19,494.50 |

| | |
|---|---|
| Increase | 30% |

Results

In the first trial of turnip, treatment with application of the composition of the invention showed an increase in 30% in yield.

### Example 4: Application of the Composition of the Invention to Potato Crops General Information

Mode of Application and Dosage

The application of the composition of the invention is done by foliar application, with conventional spraying equipment.

Previous tests carried out with the composition of the invention in potatoes have determined that the optimal dosage to be used is 0.5 liters per hectare for foliar applications independent of the irrigation level used in the field.

Applications were performed every 10-15 days.

Objective of Field Trial:

The purpose of this field trial was to determine the impact of the application of the composition of the invention on potatoes.

Time of Application

The following table shows the times of application for the potato crop.

TABLE 6
Timing of application of novel composition to potatoes

| Phenological | | Dose | Application | | Effects to be |
|---|---|---|---|---|---|
| stage | Product | (cm³/ha) | route | Objectives | observed |
| Flowering start | Novel | 500 cc | Foliar | To reduce the | Uniform |
| | composition | | application | effect of stress | Flowering |
| | of the | | | generated by this | |
| | invention | | | process. | |
| Full Bloom | Novel | 500 cc | Foliar | Reduce the effect | Uniform |
| | composition | | application | of stress | Flowering |
| | of the | | | generated by this | |
| | invention | | | process. | |
| Filling of tubers | Novel | 500 cc | Foliar | Improve root and | Leaves of intense |
| | composition | | application | vegetative growth | green color and |
| | of the | | | Improve stress | best |
| | invention | | | condition | photosynthetic |
| | | | | Improve caliber | leaf disposition. |
| | | | | Increases the | Tubers are larger |
| | | | | resistance | and more |
| | | | | diseases | uniform. Healthy |
| | | | | Improve the | plants and |
| | | | | photosynthetic | delayed |
| | | | | capacity of the | senescence |
| | | | | plant | |

Results of Field Trials

Field trials were carried out in potato crops in two different locations in Chile.

Field Trial 1

Generalities

The study was conducted in a total of 220 hectares cultivated with potatoes. The soil is soil of volcanic origin. Potato variety planted was FL1856 provided by a local industrial customer.

Main Problem:

In the case of cultivation for industrial processes, two metrics are most relevant: first overall yield and secondly the size of the tuber, since small tubers (30 mm) are not harvested by machines, and excessively large tubers are not processed by the industry.

Objective of the Trial

The purpose of this test is to assess the effect of the application of the composition of the invention on potato crops.

Materials and Method

Treatments:

T1=commercial control standard treatment of the field, 3 hectares approximate surface treated.

T2=the composition of the invention for foliar application. Treatment with three applications, a) start of flowering; (b) end of flowering and (c) pre-harvest

Dose: 0.5 Liters per hectare

Method of application: Conventional spraying equipment Irrigation: According to usual field irrigation practices.

Design of Experiment: Two adjoining blocks of equal exposure, slope, and handling, planted on the same date with the same variety were chosen.

Each unit of 3 hectares corresponded to one treatment, one of them corresponds to the application of the composition of the invention and the other is used as a non-treated control.

During the stage of tuber filling and pre-harvest, three evaluations for each treatment were made, taking in every opportunity four samples corresponding to the four repetitions, each in turn composed of four contiguous plants in completely random locations.

Tubers were identified for each plant considered for the study, and measured the equatorial zone of each tuber and finally weighing them in an electric scale.

Aspects to be Evaluated:

a. Number of tubers formed, total weight (kg) per sample.

Analysis of Results

TABLE 7
Comparison of harvested yield of potatoes in first field trial

| | | | | Accumulated | |
|---|---|---|---|---|---|
| | Weight (Kg) | | | Weight (kg) | |
| | WITH | WITH- | | WITH | WITH- |
| Plot | (T2) | OUT (T1) | Plot | (T2) | OUT (T1) |
| 1a EV 08-02 | 17.8 | 11.9 | 1a EV 08-02 | 17.8 | 11.9 |
| 2a EV 02-03 | 28.9 | 21.2 | 2a EV 02-03 | 46.7 | 33.1 |
| 3a EV 30-03 | 25.18 | 23.8 | 3a EV 30-03 | 71.88 | 56.9 |
| 4a EV 08-05 | 35.35 | 24.85 | 4a EV 08-05 | 107.23 | 81.75 |

Result:

Treatment of the potato crop with the novel composition of the invention resulted in significant yield increases.

TABLE 8
Comparison of the number of tubers in first field trial

| | | | | No cumulative | |
|---|---|---|---|---|---|
| | No. of tubers | | | tubers | |
| | WITH | WITH- | | WITH | WITH- |
| Plot | (T2) | OUT (T1) | Plot | (T2) | OUT (T1) |
| 1a EV 08-02 | 153 | 130 | 1a EV 08-02 | 153 | 130 |
| 2a EV 02-03 | 151 | 121 | 2a EV 02-03 | 304 | 251 |
| 3a EV 30-03 | 149 | 192 | 3a EV 30-03 | 453 | 443 |
| 4a EV 08-05 | 172 | 135 | 4a EV 08-05 | 625 | 578 |

Results:

Treatment of the potato crop with the novel composition of the invention resulted in increased number of tubers.

Field Trial 2

Generalities

The study was conducted in a total of 800 hectares cultivated with potatoes. The soil is soil of volcanic origin. Potato variety planted was FL1856 provided by local industrial customer.

Main Problem:

In the case of cultivation for industrial processes, two metrics are most relevant: first overall yield and secondly the size of the tuber, since small tubers (30 mm) are not harvested by machines, and excessively large tubers are not processed by the industry.

Objective of the Test

Objective of field trial:

The purpose of this field trial was to determine the impact of the application of the composition of the invention on potatoes.

Materials and Method

Treatments:

T1=commercial control with standard treatment of field operations. An area consisting of approximately 3 hectares was used in the trial.

T2=the composition of the invention for foliar application. Treatment with three applications, a) start of flowering; (b) end of flowering and (c) pre-harvest in a 20 hectares block.

Dose: 0.5 Liters Per Hectare

Method of application: Conventional spraying equipment Irrigation: According to usual field practices

Design of Experiment:

Units of 20 hectares were established due to the capacity of the pond of the equipment, with the same characteristics, with seeds of the same variety and similar planting time, considering equal treatment except for the applications of the composition of the invention.

Each unit of 20 hectares corresponded to a treatment: first: no application of the novel composition of the invention; second: foliar application of the composition of the invention,

During the stage of filling of tubers and pre-harvest, three assessments for each treatment were made, taking in every opportunity four samples corresponding to the four repetitions, each in turn composed of four contiguous plants in completely random locations.

Tubers were identified for each plant considered for the study, and measured the equatorial zone of each tuber and finally weighing them in an electric scale.

Aspects to be evaluated: Number of tubers formed, Classification of each tuber by caliber, Total weight (kg) per sample.

Analysis of Results

TABLE 9
Comparison of harvested yield of potatoes in second field trial

| | | | | Accumulated | |
|---|---|---|---|---|---|
| | Weight (kg) | | | Weight (kg) | |
| | WITH- | WITH | | WITH- | WITH |
| Plot | OUT (T1) | (T2) | Plot | OUT (T1) | (T2) |
| 1a EV 24-01 | 12.7 | 13.55 | 1a EV 24-01 | 12.7 | 13.55 |
| 2a EV 08-02 | 14.4 | 20.32 | 2a EV 08-02 | 27.1 | 33.87 |
| 3a EV 02-03 | 16.9 | 28.9 | 3a EV 02-03 | 44.0 | 62.77 |

Result:

Treatment of the potato crop with the composition of the invention resulted in significant yield increases.

TABLE 10
Comparison of number of tubers in second field trial

| | | | | No cumulative | |
|---|---|---|---|---|---|
| | No. of tubers | | | tubers | |
| | WITH- | WITH | | WITH- | WITH |
| Plot | OUT (T1) | (T2) | Plot | OUT (T1) | (T2) |
| 1a EV 24-01 | 109 | 129 | 1a EV 24-01 | 109 | 129 |
| 2a EV 08-02 | 94 | 124 | 2a EV 08-02 | 203 | 253 |
| 3a EV 02-03 | 109 | 122 | 3a EV 02-03 | 312 | 375 |

Results:

Treatment of the potato crop with the novel composition of the invention resulted in increased number of tubers.

### Example 5: Application of the Composition of the Invention to Tomatoes General Data

An area of 11.7 ha of tomatoes used for the production of processing tomatoes is divided so that part of the areas is not treated and the other is treated with the composition. The total area treated with the composition of the invention for variety is 7.05 hectares. The rest is used as control.

Objectives

The purpose of this field trial is to determine the impact of the application of the composition of the invention on tomato production. With and without standard use of field bioestimulants.

Materials and Method

There are three treatments TO (4.65 ha)=No application of composition of the invention, T1 (4.65 ha)=Foliar application of the Composition of the invention with standard treatment of field operations and T2(2.4 ha)=Foliar application of the Composition of the invention without addition conventional bio-stimulants.

Applications are made every 15 days at two doses of 0.5 (the first three) and 1 liter (two last ones) per hectare. Conventional spray equipment is used to deliver the composition of the invention.

The harvested yield (kg) of tomatoes treated with the composition is compared with the harvested yield (kg) of tomatoes without treatment.

TABLE 11
Comparison of harvested yield of tomatoes in field trial

| | Average fruit | |
|---|---|---|
| | Weight per Plant | Total Weight |
| Treatment | (kg) | (kg)/ha |
| T0 control | 1.27 | 83,672 |
| T1 | 1.77 | 68,476 |
| T2 | 2.00 | 70,663 |

Results

Treatment of tomato crop with the novel composition of the invention resulted in significant yield increases and a successful replacement of conventional bio-stimulants.

### Example 6: Application of the Composition of the Invention to Grapes General Data

An area of 10 hectares of grapes used for the production of table grapes is divided so that part of the areas is not treated and the other is treated with the composition. The total area treated with the composition of the invention for grapes is 5 hectares. The rest is used as control.

Objectives

The purpose of this field trial is to determine the impact of the application of the composition of the invention on table grape production.

Materials and Method

There are two treatments T0=No application of composition of the invention and T1=Foliar application of the Composition of the invention. Application is made using conventional spray equipment. The following table shows the times of application for the table grape crop.

TABLE 12
Timing of application of novel composition to table grapes

| Phenological | | Dose | | Application | | Effects to be |
|---|---|---|---|---|---|---|
| stage | Product | (cm³/ha) | | route | Objectives | observed |
| Sprouting | Novel | 500 | cc | Foliar | To reduce the effect | Increase |
| | composition | | | application | of stress generated | Sprouting |
| | of the | | | | by this process. | |
| | invention | | | | | |
| Flowering start | Novel | 500 | cc | Foliar | To reduce the effect | Uniform |
| (30-50%) | composition | | | application | of stress generated | Flowering |
| | of the | | | | by this process. | |
| | invention | | | | | |
| Full Bloom | Novel | 1000 | cc | Foliar | Reduce the effect of | Uniform |
| (70-100%) | composition | | | application | stress generated by | Flowering |
| | of the | | | | this process. | |
| | invention | | | | | |
| Berry Growth | Novel | 500 | cc | Foliar | Improve stress | Uniform |
| | composition | | | application | condition Improve | caliber |
| | of the | | | | cell elongation. | |
| | invention | | | | | |
| Berry Growth | Novel | 500 | cc | Foliar | Improve vegetative | Uniform |
| | composition | | | application | growth | caliber |
| | of the | | | | Improve stress | Uniform color |
| | invention | | | | condition | Healthy plants |
| | | | | | Improve caliber | |
| | | | | | Improve color | |
| | | | | | Increases the | |
| | | | | | resistance diseases | |
| Pre-harvest | Novel | 1000 | cc | Foliar | Improve soluble | Early harvest |
| | composition | | | application | solids content | Uniform |
| | of the | | | | Improve color | caliber |
| | invention | | | | Increases the | Uniform color |
| | | | | | resistance diseases | Healthy plants |

Aspects Evaluated:

Sprout growth (diameter and length)

Foliar area

Soluble Solid content (SSC)

Average grape cluster weight

Analysis of Results

TABLE 13
Comparison of table grape plant condition in field trial

| | | | Leaf | Foliar | Foliar | |
|---|---|---|---|---|---|---|
| | | Length | weight | area | area/ | ssc |
| | Diameter | (cm) | (gr) | (cm²) | Length | (°Brix) |
| T0 Control | 0.77 | 156.5 | 65.06 | 780.7 | 5.13 | 15.20 |
| T1 | 0.81 | 160.4 | 70.96 | 851.5 | 5.40 | 16.20 |

Results

Treatment of table grape with the novel composition of the invention resulted in a overall better condition.

TABLE 14
Comparison of harvested yield of table grapes from field trials

| | Average Grape | |
|---|---|---|
| | Cluster Weight | Total Weight |
| Treatment | per Plant (kg) | (kg)/ha |
| T0 Control | 23.46 | 16,750 |
| T1 | 33.08 | 23,619 |

Results

Treatment of table grape with the novel composition of the invention resulted in resulted in significant yield increases.

### Example 7: Application of the Composition of the Invention to Almonds Trees

General Data

An area of 5.3 hectares of almonds trees used for the production of almonds is divided so that part of the areas is not treated and the other is treated with the composition. The total area treated with the composition of the invention is 3.3 hectares. The rest is used as control.

Objectives

The purpose of this field trial is to determine the impact of the application of the composition of the invention on almond production.

Materials and Method

There are four treatments TO (2 ha)=No application of composition of the invention, T1(1.3 ha)=Irrigation system application of the Composition of the invention, T2(1 ha)=Foliar application of the Composition of the invention at 500 cc/ha dose and T3(1 ha)=Foliar application of the Composition of the invention at 1000 cc/ha dose. Foliar application of the composition is made with conventional spray equipment.

TABLE 15
Dose of application of the Composition of
the invention in almonds in field trial

| Treatment | Dose (cm³/ha) | | Area (ha) |
|---|---|---|---|
| T0 | Without Composition of the | | 2 |
| | invention | | |
| T1 | 500 | cc/ha | 1.3 |
| Irrigation system | | | |
| application (every 15 days) | | | |
| T2 | 500 | cc/ha | 1 |
| Foliar application | | | |
| T3 | 1000 | cc/ha | 1 |
| Foliar application | | | |

TABLE 16
Timing of Foliar application of novel composition to Almonds

| Phenological | | | |
|---|---|---|---|
| stage | Product | Objectives | Effects to be observed |
| Full Bloom | Novel composition | Improve Fruit Set | Increase Fruit set |
| (70-100%) | of the invention | Reduce the effect of | |
| | | stress generated by this | |
| | | process. | |
| Fruit Set | Novel composition | Improve caliber | Increase caliber |
| | of the invention | Improve Fruit retention | Increase fruit number |
| | | Increases the | Healthy plants |
| | | resistance diseases | |
| Pre-harvest | Novel composition | Improve caliber | Uniform caliber |
| | of the invention | Improve Fruit retention | Healthy plants |
| | | Increases the | Increase fruit number |
| | | resistance diseases | |

TABLE 17
Comparison of harvested yield of almond in field trial

| Treatment | Average Weight per Tree (kg) | Total Weight (kg)/ha |
|---|---|---|
| T0 Control | 12.4 | 5,902 |
| T1 | 11.5 | 5,474 |
| T2 | 13.5 | 6,426 |
| T3 | 16.24 | 7,730 |

Results

Foliar treatment with a 1000 cc/ha dose in Almond trees with the novel composition of the invention resulted in resulted in significant yield increases.

### Example 8: Application of the Composition of the Invention to Avocado Trees

General Data

An area of 2 hectares of avocado trees used for the production of avocado is divided so that part of the areas is not treated and the other is treated with the composition. The total area treated with the composition of the invention is 1 hectare. The rest is used as control.

Objectives

The purpose of this field trial is to determine the impact of the application of the composition of the invention on avocado production.

Materials and Method

There are two treatments T0=No application of composition of the invention and T1=Foliar application of the Composition of the invention. Applications are made every 15 days at a dose of 1 liter per hectare. Conventional spray equipment is used to deliver the composition of the invention.

Aspects Evaluated:

Frost damage

Harvested yield

TABLE 18
Comparison of frost damage in avocado trees in field trial

| Treatment | Foliage damage |
|---|---|
| T0 control | 30-40% |
| T1 | 1-5% |

Results

Treatment of avocado trees with the novel composition of the invention resulted in an increase resistance to frost damage

TABLE 19
Comparison of harvested yield of avocado in field trial

| | Average Weight per Tree | Total Weight | Percentage of |
|---|---|---|---|
| Treatment | (kg) | (kg)/ha | exportable fruit |
| T0 Control | 51.2 | 36,556 | 58.11% |
| T1 | 72.13 | 51,500 | 70.61% |

Results

Treatment of avocado trees with the novel composition of the invention resulted in resulted in significant yield increases.

### Example 9: Application of the Composition of the Invention to Pomegranate

General Data

An area of 17 hectares of pomegranate trees used for the production of pomegranate is divided so that part of the areas is not treated and the other is treated with the composition. The total area treated with the composition of the invention is 2 hectares. The rest is used as control.

Objectives

The purpose of this field trial is to determine the impact of the application of the composition of the invention on pomegranate sweetness and acidity.

Materials and Method

There are two treatments T0=No application of composition of the invention and T1=Foliar application of the Composition of the invention. Applications are made at a dose of 1 liter per hectare. Conventional spray equipment is used to deliver the composition of the invention.

TABLE 20
Timing of Foliar application of novel composition to pomegranate trees

| Phenological | | | Effects to be |
|---|---|---|---|
| stage | Product | Objectives | observed |
| Flowering start | Novel composition of | Improve Fruit Set | Increase Fruit set |
| | the invention | Improve Fruit retention | |
| | | Reduce the effect of stress | |
| | | generated by this process. | |
| Fruit Set | Novel composition of | Improve caliber | Increase caliber |
| | the invention | Increases the | Increase fruit |
| | | resistance diseases | number |
| | | | Healthy plants |
| Fruit growth | Novel composition of | Improve sweetness | Increase sweetness |
| | the invention | Improve acidity | Decrease acidity |

TABLE 21
Comparison of pomegranate condition in field trial

| | | | Acidity | |
|---|---|---|---|---|
| | Caliber | Sweetness | (Titratable | Brix/ |
| Treatment | (kg) | ° brix | acidity) | acidity |
| T0 Control | 6.14 | 12.4 | 3.1 | 3.8 |
| T1 | 6.28 | 15.1 | 2.6 | 5.6 |

Results

Treatment of pomegranate trees with the novel composition of the invention resulted in resulted in significant fruit quality increases (increasing sweetness and decreasing acidity as the variety required).

### INDUSTRIAL APPLICABILITY

The composition of the present invention can be applied in agricultural industry.

1. An agricultural composition for increasing yield of crops on which the composition is applied to, comprising at least the following active components:
a. A phytosteroids component,
b. A fulvic acid component,
c. A hydroxyacids component,
d. A carotenes component,
e. A source of ionic liquid.

2. The agricultural composition according to claim 1, wherein the phytosteroids component is 10-30% (w/v), of the total composition.

3. The agricultural composition according to claim 1, wherein the fulvic acid component is 10-40% (w/v), of the total composition.

4. The agricultural composition according to claim 1, wherein the hydroxyacids component is 1-20% (w/v), of the total composition.

5. The agricultural composition according to claim 1, wherein the carotenes component is 1-20% (w/v), of the total composition.

6. The agricultural composition according to claim 1, wherein the source of ionic liquid is 40-60% (w/v), of the total composition.

7. The agricultural composition according to claim 1, wherein the phytosteroids component corresponds to a plant extract enriched in phytosteroids.

8. The agricultural composition according to claim 7, wherein the phytosteroids component is obtained from an extract of the following selected plants: Quillaja saponaria, Phoenix dactylifera, Lolium perenne, Oryza sativa, Phalaris canariensis, Secal cereale, Triticum astivum, Zea mays, Lilium spp, Erythronium japanicum, Tulipa gesnerian, Typha latifo, Alnus glutinosa, Cannabis sativa, Gypsophilla perfoliata, Lychnis viscaria, Beta vulgaris, Castanea crenata, Fagopyrum seculentum, Rheum rhabarbarum, Apium, graveolens, Dauca spp, Arabodpsis thaliana, Brassica spp, Raphanus sativus, Cassia spp, Dolichos sp, Robinia sp, Acacia, Vicia faba, Phaseolus vulgaris, Eucalyptus, Citurs, Eriobotrya japonica, Thea sinensis, Helianthus annuus, Solidago altissima, Echium plantagineum, Pharbitis purpurea, Cucurbita moschata, Perilla frutescens, Nicotiana tabacum, Lycopersicon esculentum, Cupressus arizonica, Pinus spp, Cryptomeria japonica, Picea spp, Ginko biloba, Avena, Zea mays, Broccoli, Cauliflower, potato, oranges, apples, Brussels sprouts, onions, beans, Marchantia polymorphia amongst others but not limited to these plants.

9. The agricultural composition according to claim 1, wherein the phytosteroids component is obtained using an aqueous extraction method, comprising the following steps:
a. Grinding selected plant leaves;
b. Performing an aqueous extraction with water at a temperature selected between 40° C. to 70° C., more preferably at 60° C., producing an aqueous solution;
c. Filtering and concentrating the aqueous solution under vacuum conditions, producing a concentrate (dry extract);
d. Performing an enzymatic hydrolysis, using a estearase enzyme, producing the final phytosteroids component.

10. The agricultural composition according to claim 1, wherein the fulvic acid component is obtained from composting plant material.

11. The agricultural composition according to claim 10, wherein the plant material is selected among plant residues.

12. The agricultural composition according to claim 11, wherein the plant material is obtained from: composted material of tea, coffee, sugar cane.

13. The agricultural composition according to claim 10, wherein the plant residue is a vermin-compost.

14. The agricultural composition according to claim 13, wherein the vermin-compost is subjected to a liquid extraction producing liquid humus which is filtered, and thus is produced the fulvic acid component.

15. The agricultural composition according to claim 1, wherein the hydroxyacids component is preferably a source of β-hydroxyacid (BHA).

16. The agricultural composition according to claim 15, wherein the source of BHA is obtained from a vegetal extract, more specifically from a plant selected among Schinus molle, Salix spp.

17. The agricultural composition according to claim 16, wherein the source of BHA is obtained by an aqueous extraction of a plant selected among Schinus molle, Salix spp, which have been ground.

18. The agricultural composition according to claim 17, wherein the aqueous extraction is performed at a temperature of between 80° C. and 120° C. producing an infusion, and wherein said infusion is further filtered and later lyophilized obtaining the source of BHA.

19. The agricultural composition according to claim 1, wherein the carotenes component is obtained from an aqueous extraction of carotene-rich plants, selected from tomato, peppers, guavas, banana, carrots, pine apples plums, mangoes, nectarines, orange, peach, papaya, apricots, melons, watermelons, squash, pumpkin, sweet potatoes, spinach, corn, passion fruit, red palm oil.

20. The agricultural composition according to claim 19, wherein the aqueous extraction is lyophilized and the resulting material is subjected to a second extraction step.

21. The agricultural composition according to claim 20, wherein the second extraction step is a supercritical fluid extraction.

22. The agricultural composition according to claim 21, wherein the supercritical fluid extraction is performed using carbon dioxide as solvent, and the process is performed at a pressure of 5 to 15 MPa, more preferably at 10 MPa, producing the carotenes component.

23. The agricultural composition according to claim 1, wherein the ionic liquid is obtained by mixing liquid humus, lecithin and water.

24. The agricultural composition according to claim 23, wherein the source of ionic liquid is of a size optimal for industrial uses.
